(19) United States
(12) Patent Application Publication
(10) Pub. No.: US 2010/0244573 A1
(43) Pub. Date: Sep. 30, 2010

(54) HYBRID POWER DELIVERY SYSTEM AND METHOD

(76) Inventors: Tanay KARNICK, Portland, OR (US); Tessil THOMAS, Bangalore (IN); Ming ZHANG, Portland, OR (US); Stephanie LEUNG, Mountain View, CA (US); Don J. NGUYEN, Portland, OR (US)

Correspondence Address: KED & ASSOCIATES, LLP;INTEL CORPORATION, P.O. BOX 221200, CHANTILLY, VA, 20153-1200, US

(21) Appl. No.: 12/415,824

(22) Filed: Mar. 31, 2009

(51) Int. Cl. H02J 3/00

(52) U.S. Cl. 307/80

(57) ABSTRACT

A power control circuit includes a selector coupled to a first power source and a second power source. The selector selects power from the first power source for powering a load based on a status signal from at least the first power source. The first power source may be an environmental power source and the second power source may be another type of power source.

### FIELD

The present invention relates, in at least some of its embodiments, to controlling the supply of power to electronic devices and circuits.

### BACKGROUND

Power management in electronic devices is a continuing goal among circuit designers. Many management techniques focus on extending the lives of the batteries used to power the devices, primarily through turning off device functions in order to conserve power. Others have attempted to use different arrangements of batteries and battery chemistries. These attempts have proven inadequate for many applications. Moreover, some battery technologies may have an adverse effect on the environment.

### BRIEF DESCRIPTION OF THE DRAWINGS

FIG. 1 is a diagram showing a power control circuit in accordance with a first embodiment of the present invention.

FIG. 2 is a diagram showing a power control circuit in accordance with a second embodiment of the present invention.

FIG. 3 is a diagram showing an example of a circuit that may be used to perform dynamic impedance matching or power point tracking in accordance with one or more embodiments of the present invention.

FIG. 4 is a diagram showing an example of a circuit that may perform power-point tracking and/or impedance adjustment based on synchronous electric charge extraction in accordance with one or more embodiments of the present invention.

FIGS. 5a and 5b are diagrams showing examples of portable or handheld devices that may include or be controlled by a power control circuit in accordance with one or more of the aforementioned embodiments.

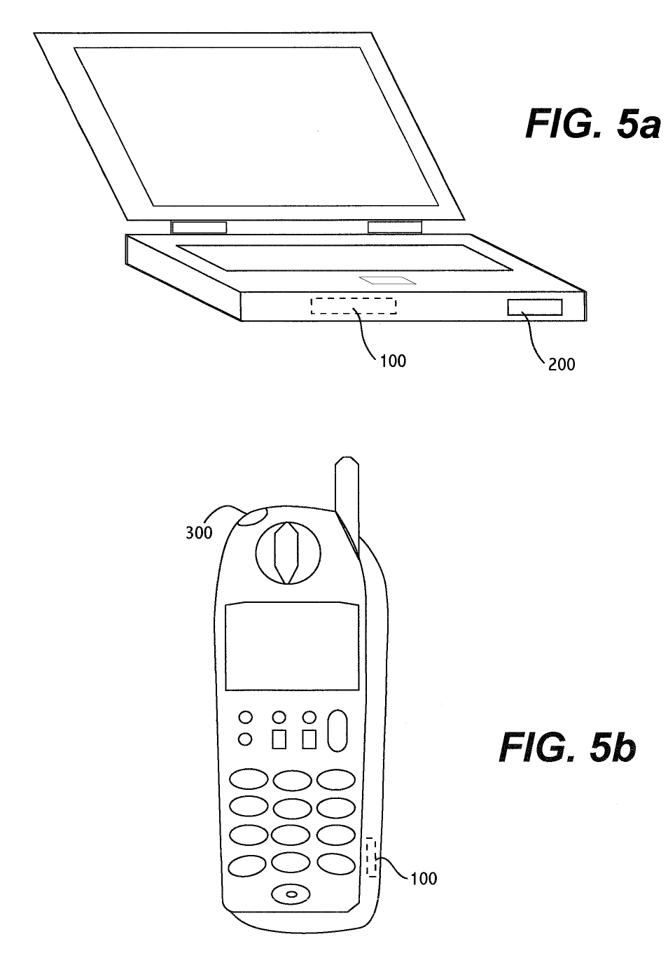

### DETAILED DESCRIPTION

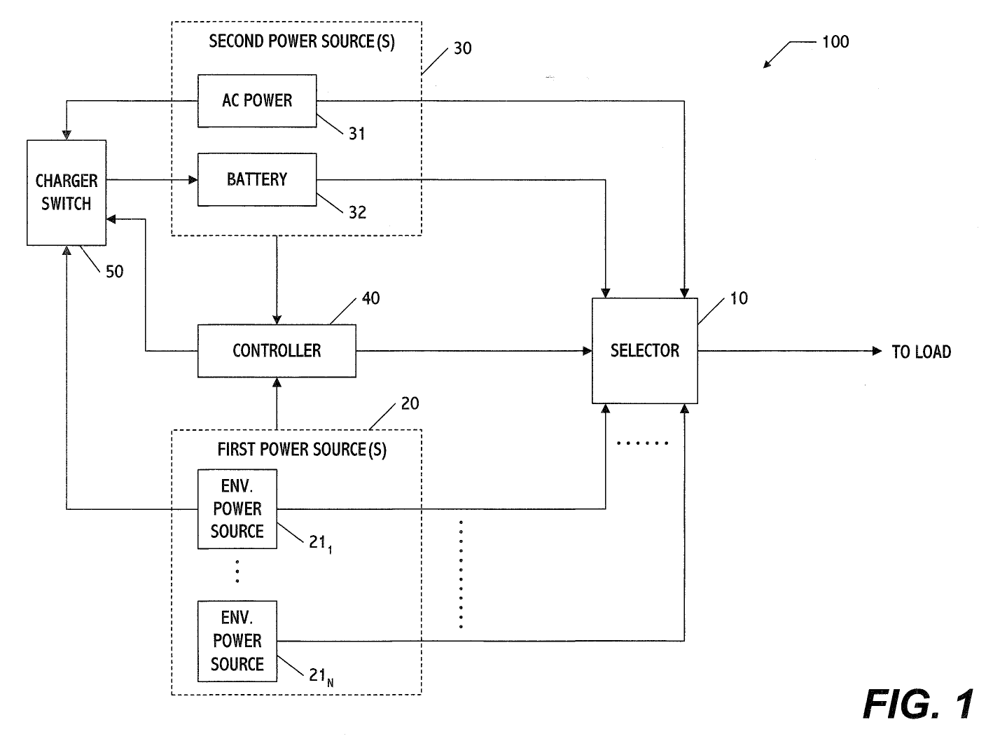

FIG. 1 shows a power control circuit 100 in accordance with a first embodiment of the present invention. The power control circuit may be used to control power in any one of a variety of electronic devices including but not limited to a notebook, desktop, or handheld computer, a mobile or cordless phone, a personal digital assistant, an e-mail terminal, a navigation device, a music/video player or receiver, a camera or camcorder, a calculator, or a Bluetooth-enabled device just to name a few.

The power control circuit includes a selector 10 that is coupled to one or more first power sources 20 and one or more second power sources 30. The first power source(s) include at least one transducing circuit that converts mechanical, light, biochemical, wind, water, and/or other forms of energy derived from the environment into electrical energy. One example includes a solar power source that includes a solar cell that collects light and converts it into voltage. For illustrative purposes, the embodiment of FIG. 1 shows that the first power source includes a plurality of environmental power sources 21₁ to 21_{N}. However, only one such power source may be included in other embodiments.

The second power source(s) include an AC power source or interface 31 or a battery 32, or both. The AC power source/interface may be, for example, an AC adaptor plug or a universal serial bus (USB) connector. As will be explained in greater detail, these more traditional power sources may be used as the sole basis of power under certain circumstances or in combination with one or more of the first power sources in powering a load coupled to the selector. For this reason, the power control circuit may be considered to function as a hybrid power delivery system because of its ability to manage the supply of power from a variety of traditional and environmental sources.

The selector selects which source, or combination of sources, is to be used in powering the load. The selector may be, for example, a switching circuit or multiplexer controlled based on a control signal generated by a controller 40. The power sources, selector, and controller may be located on a same board or within the same device as the load, or one or more of these features may be independently provided and coupled together through appropriate interfaces.

The controller performs power delivery management for supplying power to the load. In accordance with the embodiment of FIG. 1, the controller generates a signal for controlling the selector based on status signals from one or more of the first and second power source(s). For example, the controller may generate a control signal for selecting one of the first power sources when a status signal is received indicating that that power source is in a state ready to provide power. The status signal may be generated as soon as the first power source starts outputting voltage, when the first power source starts to output power that exceeds a predetermined voltage or current, or after the first power source has stored a sufficient level of voltage in an energy storage circuit sufficient to power the load, at least for a predetermined period of time.

In the case where multiple environmental power sources exist, the controller may generate control signals for independently and simultaneously selecting those sources for powering the load. This may occur, for example, when the power from any one environmental source is insufficient, in and of itself, to meet the power or operational requirements of the load. However, by combining power from multiple first power sources, those requirements may be met. The selector may be equipped with appropriate circuitry for combining power from these sources into a single conforming power signal.

The controller may also generate a control signal for selecting one of the second power sources (e.g., the battery) when a status signal is received, for example, indicating that the power from one or more of the first power sources is insufficient to power the load or otherwise is below a predetermined level, and/or when a signal is received indicating that the AC power source is not available. Such a status signal may be generated when an AC adaptor power cord is disconnected from the power control circuit or the load.

The controller may also select a combination of the first and second power sources based on their status signals. For example, in the case where the voltage of the battery falls below a predetermined level, the controller may generate control signals for causing the selector to independently and simultaneously select one of the environmental power sources and the battery. The power signal to the load will result from a combination of power from these two sources. In other embodiments, various combinations of the power sources may be independently and simultaneously selected for powering different loads or different portions of the same load.

The power from the environmental source may, therefore, seive to allow less energy from the battery to be used, thereby preserving battery life at least for as long as a sufficient level of voltage can be generated from the environmental power source. The controller may generate the control signals, for example, based on control software stored in an internal or external memory, or the control logic may be implemented in hardware or a combination of hardware and software.

As further shown in FIG. 1, the controller may control a charging process of the battery based on power from one or more of the first power sources. This may be accomplished when the controller receives a status signal from one of the first power sources indicating that the first power source is either active or, if inactive, that voltage from the power source has been stored in an associated energy storage circuit and is available for use.

When such a signal is received and another status signal is received indicating that battery level is low (e.g., has fallen below a predetermined level), the controller may automatically generate a signal to control a charger switch 50, so that energy derived from the first power source is used to charge the battery. This may occur when the load is in use and battery is low, when the load is not being actively used or is turned off, and/or when the AC power is disconnected and therefore not available for use in charging the battery.

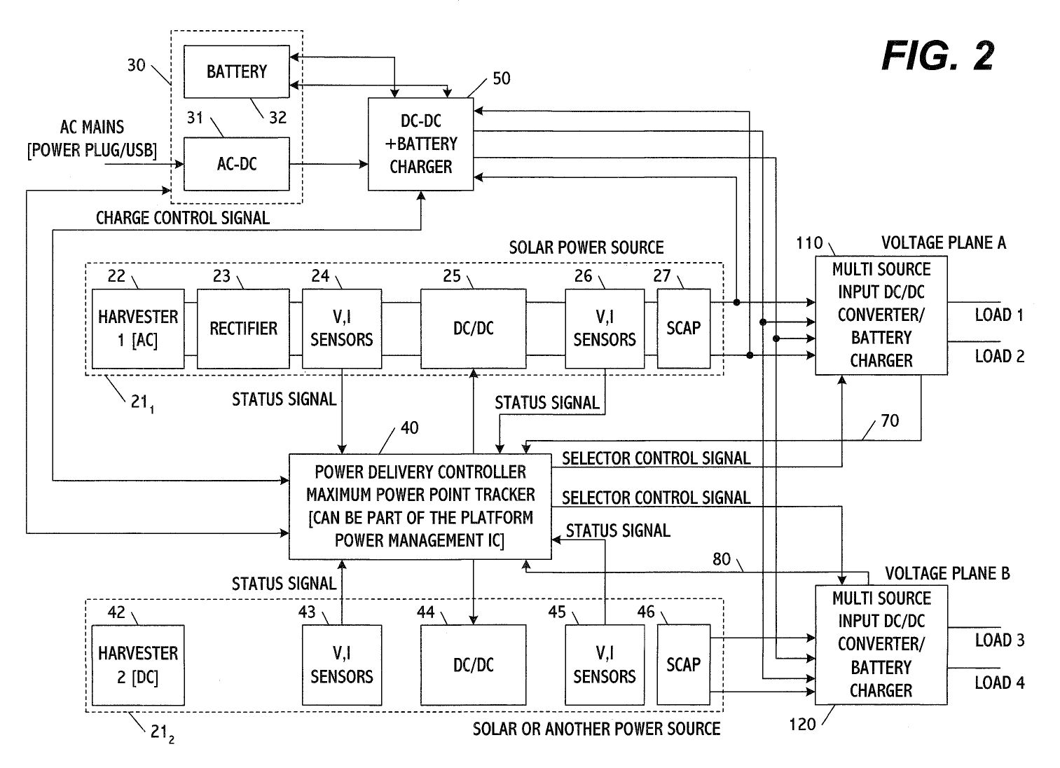

FIG. 2 shows a power control circuit in accordance with a second embodiment of the present invention. This embodiment shares some of the same features as the first embodiment and where appropriate like reference numerals are used. In the second embodiment, two environmental power sources and two traditional power sources are included. Also, two selector circuits are provided, each outputting two power signals that may be used to power different loads of a same electronic device or loads of different electronic devices. These loads are respectively shown as Load 1, Load 2, Load 3 and Load 4. According to one exemplary application, Loads 1 and 2 reside in a same voltage plane (power rail) A and Loads 3 and 4 reside in a same voltage plane (power rail) B.

The first environmental power source is a solar power source. 211. This power source includes a harvester 22, a rectifier 23, a sensor 24, a voltage converter 25, a sensor 26, and an energy storage circuit 27. The harvester may be a solar cell that converts light into electrical energy. The solar cell may convert the light into alternating current (AC), however in other embodiments a direct current output may be provided.

The rectifier converts the alternating current output from the harvester into a direct current (DC) power signal, and the sensor detects a level of the current or voltage of this signal. A status signal indicative of or derived from this level is then generated as a basis for power signal selection, as described in greater detail below. The converter 25 converts the DC signal from the rectifier from a first level to a second level that, for example, conforms to a level suitable for use in driving or powering one of the loads.

The level of power output from converter 25 is detected by sensor 26. Sensors 24 and 26 are provided to measure power (e.g., based on voltage or current) at different points within the signal path. Then, energy corresponding to this power is stored in energy storage circuit 27, which, for example, is a super capacitor (SCAP) or ultracapacitor. The energy storage circuit is coupled to selector 110 and the stored energy may be used to drive or power one of the loads if selected by the selector. In an alternative embodiment, the energy storage circuit may not be included and the output of sensor 26 may be input directly into one of the selector circuits.

A power delivery controller 40 performs a number of functions in response to status signals from sensors 24 and 26. Based on these status signals, the controller may adjust on-off periods (e.g., duty cycle) of the power switch in the DC/DC converters to make sure that the impedance presented to the energy harvester is an impedance value required for a predetermined, or maximum, power transfer from the harvester.

Essentially, this ensures that the harvester is always operating at a predetermined power delivery point. In accordance with one embodiment, this point may be the maximum power delivery point or another point based, for example, on operational or performance requirements. The controller, therefore, may use the output of sensors 24 and 26 to track the predetermined, or maximum, power point in order to allow a specific amount of power to be transferred from the harvester. This may be accomplished using, for example, a step-down converter in discontinuous conduction mode or based on a different scheme.

Once such scheme involves performing power delivery point tracking based on current status signals, voltage status signals, or both. In a current scheme, power tracking may be performed by periodically incrementing or decrementing the harvester voltage. If a given perturbation leads to an increase (decrease) in harvester power, a subsequent perturbation may be made in the same (opposite) direction. In this manner, power tracking continuously hunts or seeks the certain (e.g. peak) power conditions. The harvester voltage may also be adjusted relative to a predetermined (e.g., maximum) power point voltage by measuring incremental and instantaneous conductance of the harvester (e.g., dI/dV and I/V, respectively) based on the status sensor signals.

As shown in FIG. 2, this type of tracking may be performed in two stages relative to the DC-to-DC converter. The first stage is able to maintain the output of the harvester at a predetermined or maximum power point, and the second stage may be able to maintain a constant output from the DC-to-DC converter for storage into the super- or ultra-capacitor.

The second environmental power source 212 may include a signal-path arrangement similar to the first environmental power source. For example, the second environmental power source may include a harvester 42, a sensor 43, a voltage converter 44, a sensor 45, and an energy storage circuit 46. The harvester may be another solar panel or a different type of harvester. Examples of other types of harvesters include vibration harvesters, thermal energy harvesters, various types of mechanical energy harvesters, and wind energy harvesters. However, unlike power source 21₁, harvester 42 may have a direct current (DC) power signal output.

In operation, sensor 43 detects a level of the current or voltage of this power signal, and a status signal indicative of or derived from this level is generated as a basis for power signal selection. The converter 44 converts the DC signal from sensor 43 from a first level to a second level that, for example, conforms to a level suitable for use in driving or powering one of the loads. The second level output from converter 44 may be the same or different from the level output from converter 25. If the two are different, the difference may be attributed to different load or driving requirements of those signals.

The level of power output from converter 44 is detected by sensor 45 and then energy corresponding to this power is stored in energy storage circuit 46, which, for example, is a super capacitor (SCAP) or ultracapacitor. As far as power control, the controller may perform the same or similar type of power point tracking (e.g., maximum power point tracking) as is performed for the first environmental power source based on the outputs of sensors 43 and 45. A more detailed discussion of power point tracking and impedance control will follow.

The energy storage circuit is coupled to selector 120 and the stored energy may be used to drive or power one of the loads if selected by the selector. In an alternative embodiment, the energy storage circuit may not be included and the output of sensor 45 may be input directly into one of the selector circuits.

The power delivery controller 40 controls the selectors for powering the loads. As shown in FIG. 2, each selector receives an input from each of the power sources. The selectors may be switching circuits or multiplexers. In operation, the controller receives status signals from the sensors in each of the environmental power sources and generates control signals for the selectors based on the levels of those status signals. The controller may also generate these control signals based on status signals from the second power sources, e.g., a status signal indicating that the AC or USB power cord is not connected and therefore there is no power to be output from AC-to-DC converter 31 and/or a status signal indicating a voltage level of the battery.

According to one embodiment, the controller may independently select more than one power source in order to generate one or more combined power signals for powering one or more of the loads or for powering different loads within the same or different voltage planes. The control signals for the selectors may be generated based on the status signals from the sensors/power sources and/or based on a predetermined setting or instruction from the control software. The power delivery controller may be part of a platform power management integrated circuit.

During operation, platform power management software may assist the controller by reading out (or receiving signals indicative of) available energy from all the power sources including the battery. The read-out energy may be used by the software to decide a voltage-frequency point that will be suitable or optimal for maximizing the operational duration of the load, or which source or sources are to be selected to drive which power rail. The controller will generate signals for the selectors based on that voltage-frequency point. For power rails (voltage planes) which supply components with low duty cycles (e.g., sensors), power source selection may prove to be very useful.

The voltage-frequency point may be selected and controlled using any one of a variety of techniques. For example, the voltage-frequency point may correspond to the lowest voltage and the lowest frequency required for completing a given task. Alternatively, the operating system may decide the operating point based on the amount of idle time. If the processor is idle most of the time, then the operating system may lower power consumption by lowering voltage and frequency.

In some cases, the operating point may be selected based on the fact that there will be a deadline for completing a task. This approach is based on determining the available energy in addition to the factors mentioned above. For example, if the available energy is low, then the operating point may be adjusted to maximize the amount of time allotted for functioning. According to one scheme, the controller (and/or control software) may, first, set the voltage point by sending a voltage code to a DC-to-DC converter controller. The DC-to-DC converter controller may then adjust the duty cycle of the power switch in the converter so that the specific output voltage is achieved. In addition, the software /controller may change a phase-locked loop (PLL) multiplier and then relock the PLL to the new multiplier such that the specific frequency point is achieved.

According to one application, the platform power management software may be implemented through the controller to allow the voltage rails/planes to float with a given range, selected example, based on the requirements of the load(s) to be powered. This may significantly improve regulator efficiency.

The power delivery management architecture shown in FIG. 2 is also able to overcome any efficiency drawbacks that may be associated with the energy harvesters. As power sources, energy harvesters 22 and 42 may have radically different characteristics compared to batteries and other more traditional power sources. For example, the power output from an energy harvester tends to vary overtime with changes in environmental parameters (e.g., amount of light exposure), as well as with changes in power usage requirements of the load or host device, which as previously described may be a portable or handheld electronic device.

Moreover, the load offered to an energy harvester may influence or ensure maximum power transfer from the harvester to the load. Since the harvester output characteristic may vary over time, a dynamic impedance matching or dynamic maximum power point tracking capability may be built into the power delivery controller 40. Control software may be executed by the controller for running one or more of these dynamic schemes.

According to one embodiment, dynamic impedance matching or maximum power point tracking may be performed by the controller based on the status signals received from the voltage/current sensors in each environmental power source. This was previously discussed, but now a detailed explanation of particular techniques for performing maximum power point tracking and impedance matching for different types of (e.g., DC and AC) harvesters will now be provided.

For DC solar energy harvesters, since the load is a capacitive storage device, load current may be controlled by controlling the duty cycle of the DC-to-DC converter. This may be accomplished by sampling the solar harvester output voltage and current, and then adjusting the duty cycle based on the polarity of the change in the product of current and voltage between the current sample and the previous sample. The duty cycle may be adjusted so that the harvester operates at a predetermined or maximum power output point.

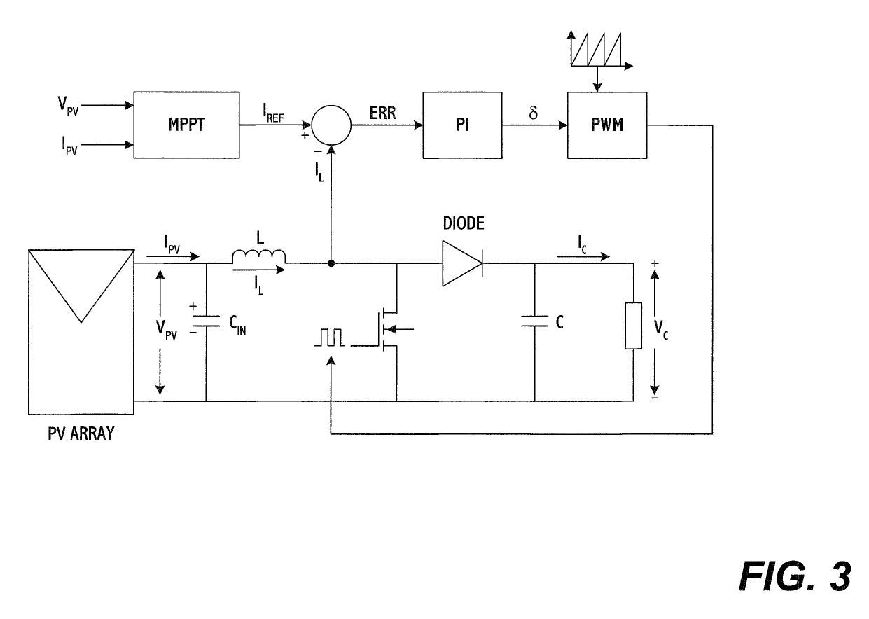

One type of DC-to-DC converter that may be used with this scheme is shown in FIG. 3. In this converter, signals Vₚᵥ and Iₚᵥ are received from the sensors and input into a maximum power point tracker (MPTT). Then, one or more of these signal are compared to reference signals and the result is used by a pulse-width modulation circuit to adjust duty cycle. Such a converter may be a current-mode-controlled boost converter because of the inherently low per-cell output voltage that may be expected from the harvester.

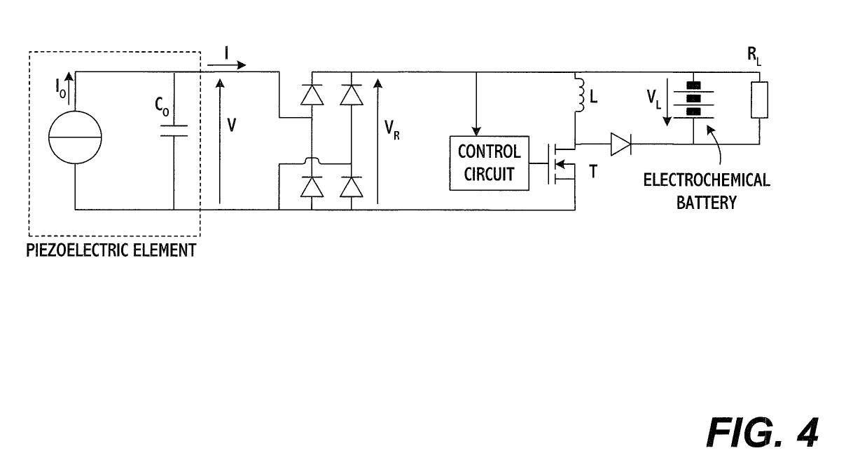

For AC harvesters like a scroll wheel or a vibrational harvester, two techniques may be used for maximum power extraction. The first technique involves synchronous electric charge extraction which, for example, may be performed by the circuit shown in FIG. 4. According to this technique, when the rectifier output (Vr) reaches a maximum or predetermined value, switch T is turned on. Then, when the rectifier voltage (Vr) reaches zero, the switch T is turned off. So, the entire energy stored the piezeoelectric element is extracted and transferred to load via the inductor.

In order to perform impedance tuning for the DC-to-DC converter, the duty cycle of the DC-to-DC converter may be varied based on the harvester output voltage and current such that the load presented to the harvester results in a maximum or predetermined power transfer. The maximum power may be considered to be transferred when the voltage across the load is half the open circuit voltage of the harvester. As previously indicated, this may be performed based on the polarity of the change in the product of the harvester current and voltage between the current sample and the previous sample. Sensing of load voltage and current may also be used as a basis for tracking the maximum power transfer point.

For vibrational harvesters, the most suitable DC-to-DC converters may be ones in a buck-type configuration because of the relatively high harvester output voltages that are expected to exist. For electromagnetic harvesters, the most suitable DC-to-DC converters may be boost-type converters because of the inherently low output voltage of these harvesters are expected to have.

By implementing dynamic impedance matching and/or dynamic maximum power point tracking, the controller will be able to ensure that an optimal or predetermined load is presented to each of the harvesters at all times. This will ensure that power transfer from the harvester to the load takes place in the most efficient manner possible, or in a sufficiently efficient manner to meet operational requirements.

The energy storage circuit in each environmental power source may also provide for improved performance. By using, for example, a super capacitor to temporarily store the energy derived from each harvester, To ensure that the supply rail/voltage plane is continuously maintained at a predetermined required level (e.g., as required by the load), the amount of usable charge left on the super capacitor may be elevated, as needed, based on the voltage of the super capacitor. This charge may be elevated, for example, by a DC-to-DC converter circuit in included within or coupled to each selector.

Eventually, the amount of charge in the super capacitor will reduce to a level where the amount output voltage cannot drive or meet the power requirements of the load. When this occurs, or when the amount of charge stored in the super capacitor falls below a predetermined level, another one of the voltage sources (e.g., the battery) may be selected to supplement the power from the super capacitor, in order to reduce the rate at which the charge in the super capacitor is consumed and in order to maintain the power to the voltage plane/power rail at the predetermined level required by the load.

Thus, for example, controller 40 may control selector 110 to output a combined power signal generated through the simultaneous selection of the output of super capacitor 27 and battery 32. When the super capacitor output voltage is insufficient, a DC-to-DC converter circuit which receives inputs from the battery and super capacitor will generate a combined power signal (supplemented by the battery power) to maintain a continuous power level output to the load.

The rime for which each source provides power may be adjusted by varying the ON time if input switch transistors in the selector circuits. This duty cycle adjustment may be performed based on the voltage levels output from the super capacitor and battery and the predetermined output voltage that is to be continuously maintained for the load. To maximize overall energy storage and transfer efficiency, the DC-to-DC converter in each selector may have a wide input voltage range (e.g., one very tolerant of supply voltage ripple), so that the amount of energy buffered and delivered using the super capacitor can be maximized. A buck-type topology, for example, may be used for the converter.

The foregoing embodiments of the power control circuit may therefore considered to beneficial because of its ability to supply harvested power directly to one or more supply rails/voltage plans in an opportunistic fashion. This will allow electronic devices to be powered efficiently and for long periods of time while extending battery life, thereby more suitably meeting the needs of users. These enhancements will especially prove to be beneficial for users of portable and/or handheld devices.

In the power control circuit of FIG. 2, controller 40 may control various operations for charging the battery. One operation involves using energy from the environmental power sources to charge the battery. To perform this operation, the controller diverts the output of one or more energy storage circuits to the battery charger 50, which will then charge the battery based on the output. This may be accomplished in accordance with a control signal generated by the controller for input into the charger. The charger may then perform a switching operation based on the control signal. The control signal into the charger may be generated based on detected state of charge of the battery, state of charge of one or more of the energy harvester paths (including the SCAPs), and/or a voltage state of the AC power source, e.g., whether an AC power or USB cord is connected.

In an alternative embodiment, the battery charger may be directly coupled to a harvester or any circuit disposed along the harvester signal path. The battery charger may also be controlled by the controller to allow AC power from the AC-to-DC converter to charge the battery.

In order to allow charging to be carried out at a predetermined current or voltage level, the battery charger may include or be coupled to a DC-to-DC converter. Charging the battery with energy from one or more of the environmental power sources will serve to extend battery life and accordingly the operational duration of the load. Power management control software may direct the controller to automatically perform a charging operation from one or more of the environmental power sources at a predetermined time, which, for example, may correspond to any time during operation of the load or after the load is shut off and a residual charge is left on one of the SCAPs.

In FIG. 2, the power signals from the AC power source (i.e., AC-to-DC converter 31) and battery 32 are shown passing through charger 50. While the charter and the DC-to-DC converter are shown in the same block, it is understood that this block may be equipned with appropriate logic and power switches to control the flow of power from the battery and AC power source along a path that either bypasses the charger or passes through it. The DC-to DC converter may adjust the level of the power from these sources before reaching the selectors.

In addition to the foregoing features, power delivery controller 40 may input signals into respective ones of the DC-to-DC converters 25 and 44 to control the DC level conversion to take place. In addition, the controller may receive signals 70 and 80 from selectors 110 and 120. These signals are essentially voltage feedback signals that may be used to perform the selection operation in the selectors. In addition to power source selection, ideally the controller may also perform the DC-to-DC converter duty cycle controlling as previously discussed.

FIGS. 3a and 3b show examples of electronic devices that may include a power control circuit in accordance with any one or more of the aforementioned embodiments. In FIG. 3a, power control circuit 100 is shown controlling power for a notebook computer. In this arrangement, the environmental power sources include a solar cell 200 which is used to supplement power from an internal battery, recharge the battery, and/or satisfy one or more load requirements of the computer as previously explained. In FIG. 3b, power control circuit 100 is shown controlling power of a mobile phone based on power from solar cell 300.

Any reference in this specification to an “embodiment” means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Furthermore, for ease of understanding, certain functional blocks may have been delineated as separate blocks; however, these separately delineated blocks should not necessarily be construed as being in the order in which they are discussed or otherwise presented herein. For example, some blocks may be able to be performed in an alternative ordering, simultaneously, etc.

Although the present invention has been described herein with reference to a number of illustrative embodiments, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

We claim:

1. A power control circuit, comprising:
a controller to detect a status signal from a first power source, and
a selector coupled to the first power source and a second power source,
wherein the first power source is an environmental power source and the second power source is different from an environmental power source, and wherein the controller is to control the selector to select power from the first power source based on the status signal from the first power source.

2. The circuit of claim 1, wherein the controller is to control the selector to select power from the first power source when a value of the signal from the first power source does not exceed a first predetermined value.

3. The circuit of claim 1, wherein the controller is to control the selector to select power from the second power source when the value of the signal from the first power source is below the first predetermined value.

4. The circuit of claim 1, wherein the controller is to control the selector to select power from the first power source and the second power source to generate a combined power signal to drive a load.

5. The circuit of claim 4, wherein the load is included in a portable electronic device.

6. The circuit of claim 1, wherein the second power source includes a battery.

7. The circuit of claim 6, further comprising:
a switch coupled between the first power source and the battery,
wherein the controller is to control the switch to allow power from the first power source to charge the battery based on a signal from the battery.

8. The circuit of claim 1, wherein the first power source is a solar power source.

9. The circuit of claim 1, further comprising:
an energy storage circuit to store energy from the first power source,
wherein energy is output from the energy storage circuit to power a load when the first power source is to be selected by the selector.

10. The circuit of claim 9, wherein the energy storage circuit includes a super capacitor.

11. A power control circuit comprising:
a first power source;
a second power source; and
a controller to control a flow of charge from the first power source to the second power source, wherein the first power source is an environmental power source and the second power source is a power source different from an environmental power source.

12. The circuit of claim 11, wherein the second power source includes a battery.

13. The circuit of claim 11, wherein the controller is to control flow of charge from the first power source to the second power source based on status signals received from the first and second power sources.

14. The circuit of claim 13, the status signal from the first power source is to provide an indication of whether charge is available from the environmental power source and the status signal from the second power source indicates a level of charge stored in a battery.

15. The circuit of claim 14, wherein the first and second power sources are to provide independent power signals to one or more loads, and wherein the controller is to control flow of charge from the first power source to the second power source based on a state of said one or more loads.

16. The circuit of claim 11, further comprising:
a super capacitor to store a charge from the environmental power source,
wherein the controller is to output power based on the charge stored in the super capacitor based on a status signal from at least one of the first power source or the second power source.

17. A power control method, comprising:
detecting a first status signal from a first power source, and
detecting a second status signal from a second power source; and
controlling a selector to select to receive power from at least one of the first power source or the second power source based on the first and second status signals, wherein the first power source is an environmental power source and the second power source is different from an environmental power source.

18. The method of claim 17, wherein the first status signal provides an indication of an amount of power derived from the environmental power source available for powering a load.

19. The method of claim 17, wherein said controlling includes controlling the selector to select both the first power source and the second power source to generate a combined power signal for powering a load based on the first and second status signals.

20. The method of claim 17, wherein the second power source is a battery and a flow of charge from the first power source to the battery is controlled during a charging operation.
